(19) United States
(12) Patent Application Publication
(10) Pub. No.: US 2024/0092989 A1
(43) Pub. Date: Mar. 21, 2024

(54) HIGH NITROGEN CONTENT POLYURETHANE FOAMS

(71) Applicant: ICP Construction, Inc., Andover, MA (US)

(72) Inventors: Andrew P. SHINKO, Uniontown, OH (US); Anthony J. TAYLOR, Medina, OH (US)

(21) Appl. No.: 18/261,004

(22) PCT Filed: Jan. 14, 2022
(86) PCT No.: PCT/US22/12568

§ 371 Date: Jul. 11, 2023

Related U.S. Application Data
(60) Provisional application No. 63/139,405, filed on Jan. 20, 2021.

(51) Int. Cl. C08J 9/14; C08G 18/16; C08G 18/18; C08G 18/24; C08G 18/32; C08G 18/76

(52) U.S. Cl. CPC C08J 9/144; C08G 18/165; C08G 18/1816; C08G 18/242; C08G 18/3281; C08G 18/3284; C08G 18/329; C08G 18/7671; C08J 2201/022; C08J 2203/162; C08J 2375/04

(57) ABSTRACT

The invention pertains generally to a shelf-stable polyurethane HFO-blown two-component polyurethane foam composition which includes incorporating nitrogen-containing aminopolyols.

### CROSS-REFERENCE TO RELATED APPLICATIONS

This application claims the benefit of priority to United States Provisional Application Ser. No. 63/139,405, filed on Jan. 20, 2021, the contents of which are incorporated herein by reference.

### TECHNICAL FIELD

The invention described herein pertains generally to a polyurethane foam composition which is blown using at least one hydrofluoroolefin (“HFO”) propellant.

### BACKGROUND OF THE INVENTION

Two-component low pressure (less than 250 psi) spray polyurethane foam (SPF) kits require a sufficient amount of blowing agent in order to fully dispense the contents of both the A-side (isocyanate) and B-side (polyols, surfactants, catalysts, etc.) chemicals. This must be done in such a manner where both A and B components are propelled at a predetermined ratio that is maintained throughout the dispensing of the product. On the other hand, one component low pressure polyurethane foam (OCF) systems are already pre-mixed in closed systems where the NB ratio is predefined. OCF systems are typically blown with hydrocarbons, but flammability concerns restrict their usage in certain sizes. Since most SPF kits are dispensed in pressurized cylinders, less flammable blowing agents must be considered. The blowing agent(s) used must be at least partially miscible with both A-sides and B-sides and should not react with either contents.

Previous blowing agents for SPF systems have included chlorofluorocarbons (CFCs) and hydrochlorofluorocarbons (HCFCs). These blowing agents, while reliable, are a threat to the stability of the ozone layer due to their ability to release chlorine atoms under ultraviolet light exposure. Free chlorine atoms readily react with ozone; therefore, compounds such as CFCs and HCFCs are said to have high ozone depletion potential (ODP). The Montreal Protocol was established in part to reduce emissions deemed responsible for the growth in the ozone layer hole. This agreement and subsequent additions were ratified by the maximum number of UN signatories. Due to this widespread acceptance, CFC and HCFC propellants were phased out and replaced by hydrofluorocarbon (HFC) blowing agents in the late 1990's and early 2000's.

HFC-134a became the non-flammable blowing agent of choice for the low-pressure SPF industry due to relative ease of transition among other factors. While HFC-134a and other HFC blowing agents have an ODP value of zero, these compounds reportedly have a high global warming potential (GWP). Unlike ODP, GWP is measured by atmospheric residence time and infrared radiation absorption relative to the Earth's atmosphere. These factors determine the radiative forcing of the molecule. A positive radiative forcing value indicates a higher potential for warming the planet; that is, more solar radiation is absorbed than reflected out to space. The radiative forcing of a particular molecule is compared against the radiative forcing of carbon dioxide. The resulting number is the GWP of the particular molecule, with carbon dioxide given a GWP of 1. Radiative forcing is not a linear quantity, however, and is dependent on external factors such as climate sensitivity and molecule-specific pulse emissions over a particular time period, denoted as time horizons measured in 20, 100, and 500 years. For instance, the global warming potential of 134a decreases with increasing time horizon, but the global warming potential of many perfluorocarbons increases with increasing time horizon. Because of this discrepancy, most GWP values are typically reported at a time horizon of 100 years. In addition, GWP values have changed over time as improved modeling and empirical data becomes readily available. To this end, the GWP of HFC-134a reported by the Intergovernmental Panel on Climate Change has changed from: 1300 in 2001; to 1430 in 2007; to 1550 in 2013.

While the abundance of HFCs in the Earth's atmosphere is much less than that of carbon dioxide, HFC emissions are projected to grow between 7-19% to that of carbon dioxide emissions by 2050. This may result in the total radiative forcing of HFCs increasing by a factor of 10 to 30 times by 2050. In light of this and other data, the Kyoto Protocol was established in order to reduce greenhouse gas emissions, which included HFCs. This new agreement has gained traction, especially in the United States. A Significant New Alternative Policy (SNAP) ruling by the EPA had established effective end dates for producing foaming products with HFC blowing agents. The current proposed date for unacceptable HFC usage is Jan. 1, 2020 for rigid polyurethane one-component foams and Jan. 1, 2021 for rigid polyurethane low pressure two-component foams. Although the rule has since been vacated, changes remain in effect at state-level and jurisdictions outside the United States. A New policy is expected in the near future.

Potential low GWP replacements for HFC blowing agents include hydrofluorooelfin (HFO) blowing agents. Specifically, the Solstice® Gas Blowing agent (GBA, HFO-1234ze, trans 1,3,3,3 tetrafluoropropene) produced by Honeywell has been proposed as a blowing agent for low pressure SPF systems. Attractive properties of HFO-1234ze include a low boiling point (−19° C.) and favorable kauri-butanol solubility (12.5 compared to 9.2 for HFC-134a). In addition, HFO-1234ze has an ODP of zero, is volatile organic carbon (VOC) exempt, and has a GWP of less than 1 due in part to its low atmospheric lifetime (˜18 days) compared with HFC-134a (13.4 years).

Although HFO blowing agents like HFO-1234ze meet requirements for the Kyoto Protocol (GWP<150) and are cleared for use under SNAP 21, the short lifespan of the molecule has led to challenges with the product shelf life of closed SPF systems. Stated earlier, SPF systems contain A-side (isocyanate) and B-side (resin) components stored separately under pressure. Both contents require propellants to fully dispense these mixtures. HFO-1234ze and other HFO blowing agents tend to break down and interact with moieties in the B-side. HFO molecules are believed to react with amine catalysts, for example, via nucleophilic substitution. This reaction is believed to produce hydrofluoric acid, which in turn attack surfactants and polyols. Such phenomenon has been observed via nuclear magnetic resonance (NMR) and gas chromatography-mass spectrometry. These undesirable reactions yield a significant reduction in foam properties, particularly gelation and tack-free times, foam appearance, cell structure, and mechanical properties among others. Consequently, a simple 1:1 substitution of an HFC blowing agent with an HFO blowing agent in a polyurethane SPF system can reduce shelf life from one year or greater to a matter of weeks or days. Therefore, systems that were stable in HFCs must undergo modifications in order to meet the demand of shelf life stability and superior foam properties. HFO-1234ze was selected as the blowing agent of choice for this study.

This invention was developed to overcome some of the limitations of the teachings of the prior art as well as to address long term stability issues when using HFO propellants in blowing polyurethane foams having a high nitrogen content, i.e., a theoretical nitrogen content greater than 1% in the synthesized foam by the use of amino polyol reactants containing nitrogen. The prior art appears to teach that successful polyurethane foams can only be synthesized when using amino polyols which have a nitrogen content of less than 1%, preferably less than 0.4%.

The present invention overcomes some of the limitations taught in the prior art by teaching that higher loading of nitrogen in the synthesized polyurethane foam is possible in HFO blown two-component polyurethane foams, this improvement being achieved by the use of a catalyst package in combination with a high nitrogen content amino polyol.

### SUMMARY OF THE INVENTION

The present invention is directed generally to a shelf-stable polyurethane HFO-blown two-component polyurethane foam composition which includes using amino polyols having a high nitrogen content to control the amount of nitrogen in the overall synthesized polyurethane foam to greater than 1%.

In one aspect of the invention, a low-pressure two-component polyurethane foam composition is described in which “A-side” and “B-side” reactants comprise: at least one A-side diisocyanate and at least one HFO propellant; at least one, preferably two, B-side polyols, at least one of the polyols comprising an aminopolyol, at least one B-side plasticizer, at least one surfactant, at least one catalyst, often water, but water is not required, and at least one HFO propellant; wherein the at least one catalyst comprises at least one metal-containing catalytic compound, and preferably at least one metal-containing catalytic compound (Sn or K) with at least one a nitrogen-containing catalytic compound which has at least one 6-membered ring groups attached to the nitrogen (preferably two 6-membered rings attached to the nitrogen), wherein a theoretical nitrogen content of the polyurethane foam composition is greater than 1.0; and a catalytic decay ratio of the polyurethane foam being approximately equal to or less than 2.5, more preferably approximately equal to or less than 2.0.

In another aspect of the invention, the at least one nitrogen-containing catalytic compound has at least one 6-membered ring groups attached to the nitrogen, preferably at least two 6-membered rings attached to the nitrogen.

In another aspect of the invention, the low-pressure two-component polyurethane foam composition will utilize n-methyldicyclohexylamine for the at least one nitrogen-containing catalytic compound and di-N-butylbis(dodecylthio)tin for the at least one metal-containing catalytic, compound.

In one embodiment, the low-pressure two-component polyurethane foam composition will be synthesized using at least one amino polyol which contains less than or equal to approximately 8 wt. % nitrogen, preferably less than or equal to approximately 7 wt. % nitrogen, more preferably less than or equal to approximately 6 wt. % nitrogen; most preferably less than or equal to approximately 5 wt. % nitrogen; and at times, less than or equal to approximately 4 wt. % nitrogen.

The synthesized low-pressure two-component polyurethane foam composition will often include less than approximately 2.5 wt. % of added water; and less than approximately 5 wt. % of added glycerin.

The at least one amino polyol is selected from the group consisting of

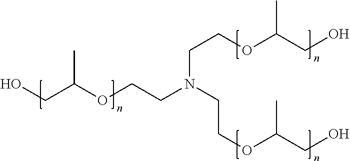

wherein n ranges from ˜1 to ˜50; and

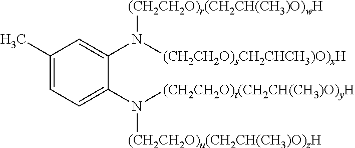

wherein 1<r+s+t+u+v+w+x+y+z<8.5; and further wherein r, s, t, u, v, w, x, y and z independently range from 0 to 10 inclusive;

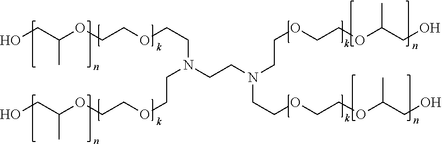

wherein n and k independently range from ˜1 to ˜25 inclusive.

In another embodiment, the polyurethane foam will have the at least one amino polyol is selected from the group consisting of

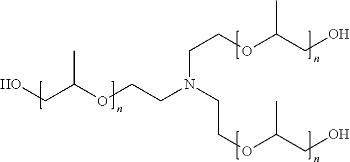

wherein n ranges from 1 to 50; and

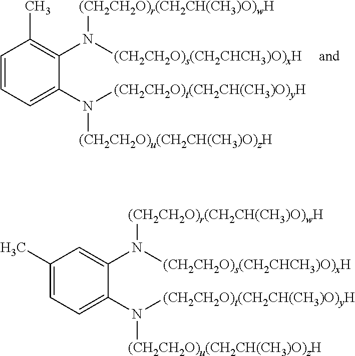

wherein 1<r+s+t+u+v+w+x+y+z<8.5 and further wherein r, s, t, u, v, w, x, y and z independently range from 0 to 10 inclusive.

These and other objects of this invention will be evident when viewed in light of the drawings, detailed description and appended claims.

### BRIEF DESCRIPTION OF THE DRAWINGS

FIG. 1 is a graph of CDR ratio over time of several synthesized polyurethane foams.

### DETAILED DESCRIPTION OF THE INVENTION

The best mode for carrying out the invention will now be described for the purposes of illustrating the best mode known to the applicant at the time of the filing of this invention. The examples and figures are illustrative only and not meant to limit the invention, as measured by the scope and spirit of the claims.

Unless the context clearly indicates otherwise: the word “and” indicates the conjunctive; the word “or” indicates the disjunctive; when the article is phrased in the disjunctive, followed by the words “or both” or “combinations thereof” both the conjunctive and disjunctive are intended.

As used in this application, the term “approximately” is within 10% of the stated value, except where noted.

As used in this application, the term “catalytic decay ratio” or “CDR” is defined as the ratio of accelerated aging gel time to that of initial gel time. This value was recorded in order to determine gel time shift over the age of the system. A low CDR would indicate greater catalytic stability over that of a high CDR. For long term stability, the CDR ratio should remain less than or equal to approximately 2.5, more preferably less than or equal to approximately 2.0.

As also used in this application, “shelf life” means a polyurethane foam which when subjected to accelerated aging, still results in a foam having physical properties such as foam height, gel time, density, etc., preferably within approximately 25% of those parameters prior to accelerated aging.

As further used in this application, “accelerated aging” means storing the reactant combination and propellant at 50° C. for 12-48 days prior to reacting the “A” and “B” cylinders and spraying the polyurethane foam. Using the Arrhenius equation, this equates to 3-12 months at room temperature.

As additionally used in this application, “low-pressure” means a pressure less than 250 psi at room temperature. Typically, the pressure in the full cylinders is between approximately 130-250 psi.

As used in this application, “amino polyol” means a polyol, including, but not limited to polyester polyols, polyether polyols, natural polyols, polycarbonate polyols, etc., having a nitrogen content of at least about 1% by weight, preferably at least ˜1.1% by weight, preferably at least ˜1.2% by weight, preferably at least ˜1.3% by weight, preferably at least ˜1.4% by weight, preferably at least ˜1.5% by weight, preferably at least ˜1.6% by weight, preferably at least ˜1.7% by weight, preferably at least ˜1.8% by weight, preferably at least ˜1.9% by weight, preferably at least ˜2.0% by weight, preferably at least ˜2.2% by weight, preferably at least ˜2.4% by weight, preferably at least ˜2.6% by weight, preferably at least ˜2.8% by weight, preferably at least ˜3.0% by weight, preferably at least ˜3.5% by weight, preferably at least ˜4.0% by weight, preferably at least ˜4.5% by weight, preferably at least ˜5.0% by weight, preferably at least ˜5.5% by weight, preferably at least ˜6.0% by weight, preferably at least ˜7% by weight, preferably at least ˜8% by weight, preferably at least ˜9% by weight, preferably at least ˜10% by weight, preferably at least ˜12% by weight.

The literature would appear to teach that polyol pre-mixes contain less than 1 wt. % nitrogen based on the weight of the polyol pre-mix, and preferably the polyol premix has a nitrogen content not exceeding 0.1 wt. % nitrogen based on the weight of the polyol pre-mix (see United States Published Patent Application 2018/0079881 A1).

The invention will now be described by a series of examples and identification of various reactants used in the invention.

Polyols

As illustrated in a non-exhaustive, non-exclusive, exemplary list below, there are a myriad of polyols (both polyester polyols and polyether polyols) which are useful in effecting the reaction with a diisocyanate to form a foam having varying characteristics. The ability to add widely varying amounts of polyols and/or different polyol combinations could easily be affected via either supplementing existing amounts of “B-side” polyol(s) via the third stream or by essentially eliminating “B-side” polyol(s) and making their addition via the third stream. In one aspect of the invention, the polyol(s) are added by using a pumping mechanism from a “B-side” cylinder or other container, and the third stream is employed to add the blowing agent and/or pressurizing agent.

Polyester Polyol(s)

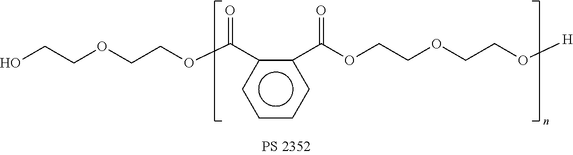

| | |
|---|---|
| Hydroxyl Number, mg KOH/g | 230-250 |
| Water, % by wt., max. | 0.15 |
| Acid Number, mg KOH/g, max. | 0.6-1.0 |
| Viscosity at 77° F. (25° C.), cP | 2,000-4,500 |
| Equivalent Weight (average) | 234 |
| Molecular Weight (average) | 468 |
| Color, Gardner | 4 |
| Density at 77° F. (25° C.), lb./U.S. gal | 9.9 |
| n | 1-30 |
| Specific Gravity at 77° F. (25° C.) | 1.19 |

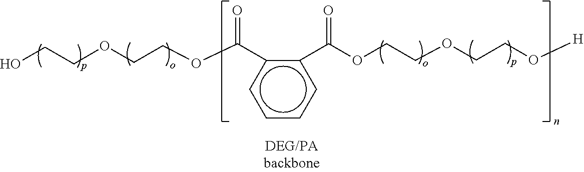

n ranges from 1-30 inclusive;
o ranges from 1 to 5 inclusive; and
p ranges from 1 to 5 inclusive;

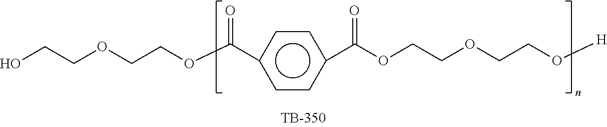

| Hydroxyl Number, mg KOH/g | 335-365 |
|---|---|
| Water, % by wt., max. | 0.15 |
| Acid Number, mg KOH/g, max. | 0.5-2.0 |
| Viscosity at 77° F (25° C.), cP | 2,500-3,500 |
| Color, Gardner | 4-5 |
| Specific Gravity at 77° F. (25° C.) | 1.233 |
| Functionality | 2.2 |
| n | 1-25 |
| DEG/TA backbone (diethylene glycol terephthalate anhydride) | 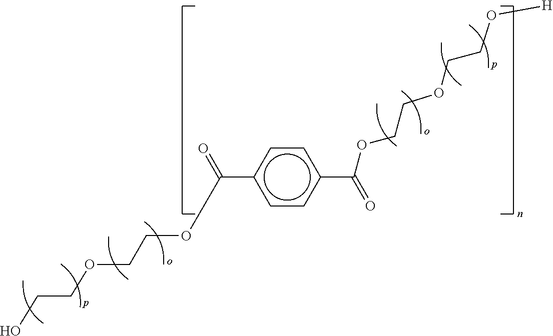 |
| | n ranges from 1-30 inclusive; |
| | o ranges from 1 to 5 inclusive; and |
| | p ranges from 1 to 5 inclusive; |
| Stepanpol ® | Aromatic diethylene glycol-phthalic anhydride polyester polyol (DEG/PA backbone)- |
| PS-3152 | avg. viscosity @ 25° C. ~2756 cP; Avg. ~350; and Hydroxyl Value (mgKOH/g) |
| | ~300-350 |
| Isoexter 3061 | Aromatic phthalic anhydride polyester polyol |
| Stepanpol ® | Saturated polyester polyol (DEG/AA backbone) wherein AA = adipic acid)- avg. |
| PC 2011-225 | viscosity @ 25° C. ~400-600 cP; Avg. MW ~500; and Hydroxyl Value (mgKOH/g) |
| | ~215-235 |
| Stepanpol ® | Hybrid phthalate anhydride polyester polyol (DEG/PA backbone)- avg. viscosity @ |
| PDP-70 | 25° C. ~1900 cP; Avg. MW ~1600; and Hydroxyl Value (mgKOH/g) ~70 |
| Stepanpol ® | Aromatic polyester polyol |
| PS-3422 | |
| Stepanpol ® | Aromatic phthalic anhydride polyester polyol (DEG/PA backbone)- avg. viscosity @ |
| PS-1752 | 25° C. ~3900 cP; Avg. MW ~640; and Hydroxyl Value (mgKOH/g) ~175 with some |
| | propylene carbonate (unspecified by the manufacturer) |

Furthermore without being bound to any one theory or mode-of-operation, it is believed that the use of glycerin as a fluoride ion scavenger may beneficially increase the shelf life stability of this product. Note that it is now possible to have significant amounts of polyester polyols and polyether polyols in the composition, provided that at least some glycerin (synonymously “glycerol”) is also present, a simple triol. It is recognized that the fluoride ion scavenger will preferably have a functionality of≥2.0, preferably≥2.2.

While glycerin is one specific example of a triol with scavenging capabilities, the invention is not limited to such. In fact, lower molecular weight polyols, e.g., a triol or specifically a polyol (including diols) having a functionality≥2, preferably≥2.2 are believed to be useful in this invention. Molecular weight ranges of the polyol(s) are anticipated to range between ˜90 to ˜1500 g/mol are believed to be applicable to this invention.

Polyether Polyol(s) (actual and potential)

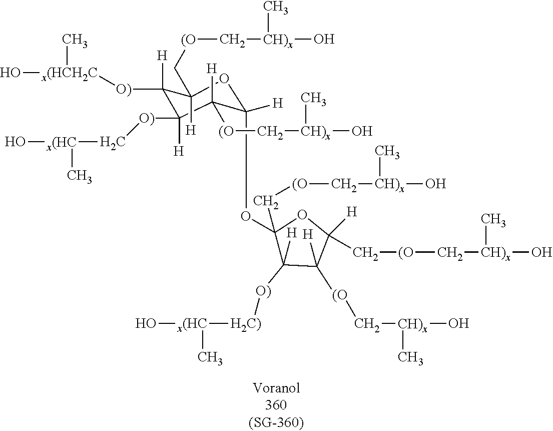

sucrose polyether polyol based on a sucrose-glycerol mixture with a functionality of
~4.5 having a hydroxyl number of ~360 wherein x ranges from 1 to 100

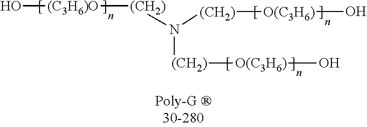

glycerin-based oxypropylated polyether polyol having a functionality greater than or
equal to 3 and a molecular weight of about 600, an OH number of about 274, an acid
number (max) of 0.05, an average pH of about 6.5 wherein n ranges from 2 to 50

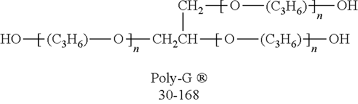

1,2,3-propanetriol, methyloxirane polymer wherein n ranges from 2 to 50

| Poly-G ® | Polyether triol having an average molecular weight of ~4,000, an OH number of about |
|---|---|
| 30-42 | 40, an acid number (max) of ~0.03, an average pH of about 5.5 |

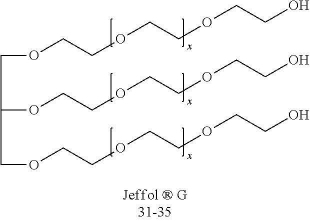

ethylene oxide triol, ethylene oxide capped, and glycerin initiated wherein the polyol
has a hydroxyl number of ~35 and a M.W. of ~4800 and provides for chain
entanglement and packing without distorting a profile wherein x ranges from 2 to 50.

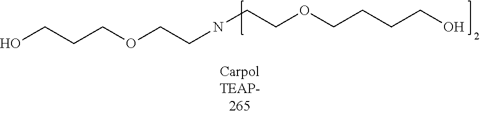

3,3′,3″-[nitrilotris(ethane-2,1-diyloxy)]tripropan-1-ol

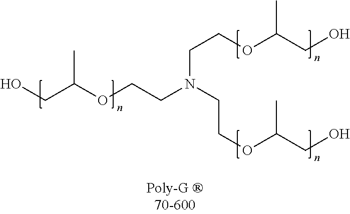

ethoxylatedtriethanolamine wherein n ranges from 1 to 50

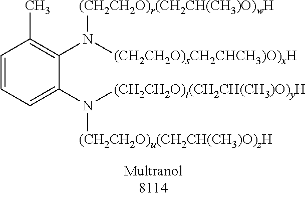

and

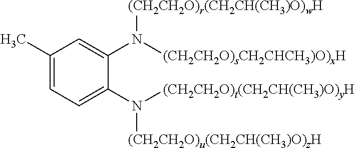

wherein 1 <r + s + t + u + v + w + x + y + z <8.5
r, s, t, u, v, w, x, y and z independently range from 0 to 10 inclusive
OH # is 388, MW is 578 g/mol
estimated nitrogen content ~4.93 wt. %

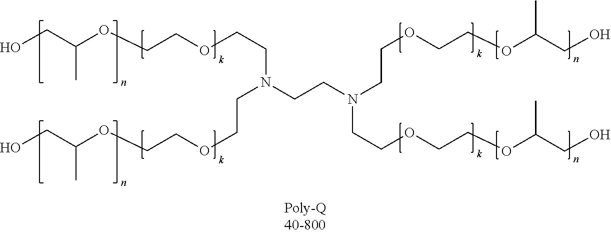

OH # is 800, MW is 278 g/mol
estimated nitrogen content is ~10.07 wt. %
wherein n and k range from 1 to 25 inclusive

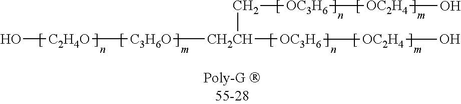

Block copolymer of propylene oxide and polyethylethylene oxide having a nominal
molecular weight of 4,000 and wherein n & m are integers ranging from 2 to 50.

| | |
|---|---|
| Poly-G | Polyether polyol having a hydroxyl number of ~112 and a M.W. of ~1000 and a |
| 20-112 | viscosity @ 25° C. of ~145 cP |

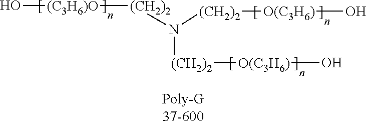

Ethanol, 2,2′ imino bis, polymer with 2-methyl oxirane, a polyether triol having a
hydroxyl number of ~600 and a M.W. of ~163-280 and a viscosity @ 25° C. of ~380
cP
estimated nitrogen content is ~4.98 wt. %

Flame Retardants and/or Plasticizers

As illustrated in a non-exhaustive, non-exclusive, exemplary list below, there are a myriad of flame retardants and/or plasticizers which are useful in modifying the properties of the reaction of a polyol with a diisocyanate to form a foam having varying characteristics. The ability to add widely varying amounts of flame retardants/plasticizers and/or different flame retardant/plasticizer combinations could easily be effected via either supplementing existing amounts of “B-side” flame retardant(s)/plasticizer(s) via the third stream or by essentially eliminating “B-side” flame retardant(s)/plasticizer(s) and making their addition via the third stream.

| | |
|---|---|
| Tris (1-chloro-2-propyl) phosphate (“TCPP”) | 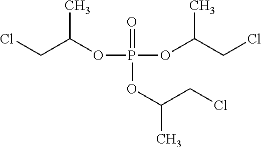 [SMILES: CC(CCl)OP(=O)(OC(C)CCl)OC(C)CCl] |
| Tetrabromophthalate diol (“PHT4-diol”) | 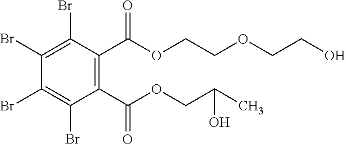 [SMILES: CC(O)COC(=O)c1c(Br)c(Br)c(Br)c(Br)c1C(=O)OCCOCCO] |

Surfactants

As illustrated in a non-exhaustive, non-exclusive, exemplary list below, there are a myriad of surfactants which are useful in modifying the properties of the reaction of a polyol with a diisocyanate to form a foam having varying characteristics. The ability to add widely varying amounts of surfactants and/or different surfactant combinations could easily be affected via either supplementing existing amounts of “B-side” surfactant(s) via the third stream or by essentially eliminating “B-side” surfactant(s) and making their addition via the third stream.

| Trade name | Composition (if known) |
|---|---|
| Tegostab ® B-8433 | Polyether polydimethylsiloxane copolymer |
| Tegostab ® B-8870 | Polyether polydimethylsiloxane copolymer |
| Dabco ® LK ®-443 | Non-silicone organic surfactant |
| Nonoxynol-9 | 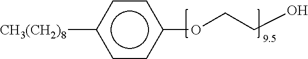 |
| | the hydroxyl number is ~88 |
| L12-8 ethoxylated alcohol (dodecyl alcohol ethoxylate) | 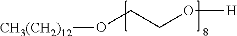 |
| Tegostab ® B-8465 | Polyether polydimethylsiloxane copolymer |
| Surfonic N-95 | ethylene oxide content of 65.5% & |
| | HLB value of 13.1 |

Catalysts

As illustrated in a non-exhaustive, non-exclusive, exemplary list below, there are a myriad of catalysts which are useful in effecting the reaction of a polyol with a diisocyanate to form a foam having varying characteristics. The ability to add widely varying amounts of catalysts and/or different catalyst combinations could easily be affected via either supplementing existing amounts of “B-side” catalyst(s) via the third stream or by essentially eliminating “B-side” catalyst(s) and making their addition via the third stream.

| Trade name and/or Chemical name | Chemical structure |
|---|---|
| Dabco ® K-15 (Potassium octoate/DEG (diethylene glycol)) | 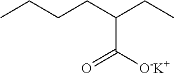 |
| Dabco ® TMR-20 | Proprietary K-carboxylate composition |
| DABCO ® T-120/Patcat 3014 | (CH₃(CH₂)₃)₂—Sn—S(CH₂)₁₁CH₃ |
| (dibutyl tin dilauryl mercaptide) | |
| Polycat ® 12 | 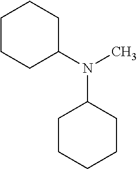 |
| DMDEE (2,2′-dimorpholinediethylether) | 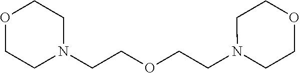 [SMILES: C1CN(CCOCCN2CCOCC2)CCO1] |

Other

Water can be both beneficial and deleterious to catalyst foams, depending on the blowing agent used or the end-use application. The ability to add widely varying amounts of water could easily be affected via either supplementing existing amounts of “B-side” water via the third stream or by essentially eliminating “B-side” water and making its addition via the third stream of a spray gun.

Glycerin has been found to be beneficial to the reactant mix and is one specific example of a triol with scavenging capabilities, the invention is not limited to such. In fact, lower molecular weight polyols, e.g., a triol or specifically a polyol (including diols) having a functionality≥2, preferably≥2.2 are believed to be useful in this invention. Molecular weight ranges of the polyol(s) are anticipated to range between ˜90 to ˜1500 g/mol are believed to be applicable to this invention.

Blowing Agent(s)

As illustrated in a non-exhaustive, non-exclusive, exemplary list below, there are a myriad of blowing agents which are useful in effecting the reaction of a polyol with a diisocyanate to form a foam having varying characteristics. The ability to add widely varying amounts of blowing agents and/or different blowing agent combinations could easily be effected via either supplementing existing amounts of “A-side” and/or “B-side” blowing agent(s) via the third stream or by essentially eliminating blowing agent(s) and making their addition via the third stream.

In one aspect of the invention, blowing agents having up to four carbon atoms in their backbone and which are useful in this invention fall within the general formula (I) illustrated below:

[CVₐ]ₘ−A−[CX_{b}]ₙ−B−[CY_{c}]ₒ−D−[CZ_{d}]ₚ

wherein
C is a carbon atom;
V, X, Y & Z are independently selected from the group consisting of H, F and CI;
a & d are independently selected from the integral values ranging from 0 to 3 inclusive;
b & c are independently selected from the integral values ranging from 0 to 2 inclusive;
o, p & n are equal to 1;
m is selected from the integral values ranging from 0 to 1 inclusive;
A, B & D are covalent bonds sufficient to satisfy the available bonding sites of adjacent carbon atoms, if such carbon atoms are present; and

the blowing agent, including miscible blends and azeotropes thereof, having a boiling point between approximately −5° C.-50° C., and an ozone depletion potential of essentially zero; and

in a preferred embodiment, the blowing agent is non-flammable, recognizing that co-blowing agents may be flammable, although in a more preferred embodiment, the co-blowing agent will be added in such an amount as to render the combination non-flammable either as a blend or as an azeotrope.

In another aspect of the invention, and listed more generically, the blowing agents having up to six carbon atoms in their backbone and which are useful in this invention fall within the general formula (II) illustrated below:

[CUₑ]_{q}−E−[CW_{f}]ᵣ−F−[CVₐ]ₘ−A−[CX_{b}]ₙ−B−[CY_{c}]ₒ−D−[CZ_{d}]ₚ

wherein
C is a carbon atom;
U, W, V, X, Y and Z are independently selected from the group consisting of H, F and CI;
d & e are independently selected from the integral values ranging from 0 to 3 inclusive;
a, b, c & f are independently selected from the integral values ranging from 0 to 2 inclusive;
o, p & n are equal to 1;
m, q & r are independently selected from the integral values ranging from 0 to 1 inclusive;
A, B, D, E and F are covalent bonds sufficient to satisfy the available bonding sites of adjacent carbon atoms, if such carbon atoms are present;

the blowing agent having a boiling point between approximately −5° C.-50° C., and an ozone depletion potential of not greater than 0.05; and

in a preferred embodiment, the blowing agent is non-flammable, recognizing that co-blowing agents may be flammable, although in a more preferred embodiment, the co-blowing agent will be added in such an amount as to render the combination non-flammable either as a blend or as an azeotrope.

As illustrated in a non-exhaustive, non-exclusive, exemplary list below, there are a myriad of blowing agents which are useful in effecting the reaction of a polyol with a diisocyanate to form a foam having varying characteristics. The ability to add widely varying amounts of blowing agents and/or different blowing agent combinations could easily be effected via either supplementing existing amounts of “A-side” and/or “B-side” blowing agent(s) via the third stream or by essentially eliminating blowing agent(s) and making their addition via the third stream.

| | |
|---|---|
| HFO 1234ze(E) (1,3,3,3-tetrafluoropropene) | 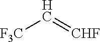 |
| HFO-1233zd(E) sold commercially under the name (Solstice LBA) (E) 1-chloro-3,3,3-trifuloro-propene (trans isomer) | 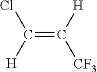 |
| Opteon 1150 (E) (trans-1,1,1,4,4,4 hexafluoro-2-butene) | 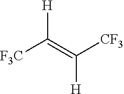 |
| Opteon 1100 (Z) (cis-1,1,1,4,4,4-hexafluoro-2-butene) | 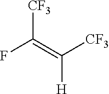 [SMILES: F/C(=C/C(F)(F)F)C(F)(F)F] |

As used in this application, a non-limiting definition for the term “blowing agent” which includes miscible mixtures and azeotropes of blowing agents, means a propellant or solvent which are useful and provide efficacy to various applications in the form of performance, pressure performance, or solubility, without deleterious effect due to molar gas volume, flammability migration, or GWP reduction, yet which have a vapor pressure within defined limits as defined herein. Exemplary and non-limiting blowing agents include HFO-1233zd(E), HFO-1336mzz or sold under the trade name Opteon° 1100 (Chemours), namely cis-1,1,1,4,4,4 hexafluoro-2-butene or Opteon® 1150 (Chemours), namely trans-1,1,1,4,4,4 hexafluoro-2-butene

And while the above identified blowing agents are preferred from an ozone depletion potential (ODP) perspective as well as a global warming potential (GWP) perspective, the third stream within the spray gun offers the ability to use a myriad of blowing agents, alone or in combination with others, the combination in one aspect including all non-flammable blowing agents, while in another aspect including a combination of non-flammable and flammable blowing agents. A non-limiting list of other blowing agents includes, but is not limited to air, C₁ to C₆ hydrocarbons, C₁ to C₈ alcohols, ethers, diethers, aldehydes, ketones, hydrofluoroethers, C₁ to C₄ chlorocarbons, methyl formate, water, carbon dioxide, C₃ to C₄ hydrofluoroolefins, and C₃ to C₄ hydrochlorofluoroolefins. Examples of these non-exclusively include one or more of difluoromethane, trans-1,2-dichloroethylene, difluoroethane, 1,1,1,2,2-pentafluoroethane, 1,1,2,2-tetrafluoroethane, 1,1,1,2-tetrafluoroethane, 1,1,1-trifluoroethane, 1,1-difluoroethane, fluoroethane, hexafluoropropane isomers, including HFC-236fa, pentafluoropropane isomers of HFC-245fa, heptafluoropropane isomers, including HFC-227ea, hexafluorobutane isomers, and pentafluorobutane isomers including HFC-365mfc, tetrafluoropropane isomers, and trifluoropropene isomers (HFO-1243). Specifically included are all molecules and isomers of HFO-1234, including 1,1,1,2-tetrafluoropropene (HFO-1234yf), trans-1-chloro-3,3,3-trifluoropropene (HFO-1233zd(E)) sold under the trade name Solstice LBP by Honeywell and cis- and trans-1,2,3,3-tetrafluoropropene (HFO-1234ye), HFC-1233zd, and HFC-1225ye. The blowing agents may be used in combination with at least one co-blowing agent which non-exclusively include: hydrocarbons, methyl formate, halogen containing compounds, especially fluorine containing compounds and chlorine containing compounds such as halocarbons, fluorocarbons, chlorocarbons, fluorochlorocarbons, halogenated hydrocarbons such as hydrofluorocarbons, hydrochlorocarbons, hydrofluorochlorocarbons, hydrofluoroolefins, hydrochlorofluoroolefins, CO₂, CO₂ generating materials such as water, and organic acids that produce CO₂ such as formic acid. Examples non-exclusively include low-boiling, aliphatic hydrocarbons such as ethane, propane(s), i.e. normal pentane, isopropane, isopentane and cyclopentane; butanes(s), i.e. normal butane and isobutane; ethers and halogenated ethers; trans 1,2-dichloroethylene, pentafluorobutane; pentafluoropropane; hexafluoropropane; and heptafluoropropane; 1-chloro-1,2,2,2-tetrafluoroethane (HCFC-124); and 1,1-dichloro-1-fluoroethane (HCFC-141b) as well as 1,1,2,2-tetrafluoroethane (HFC-134); 1,1,1,2-tetrafluoroethane (HFC-134a); 1-chloro 1,1-difluoroethane (HCFC-142b); 1,1,1,3,3-pentafluorobutane (HFC-365mfc); 1,1,1,2,3,3,3-heptafluoropropane (HCF-227ea); trichlorofluoromethane (CFC-11), dichlorodifluoromethane (CFC-12); 1,1,1,3,3,3-hexafluoropropane (HFC-236fa); 1,1,1,2,3,3-hexafluoropropane (HFC-236ea); difluoromethane (HFC-32); difluoroethane (HFC-152a); trifluoropropenes, pentafluoropropenes, chlorotrifluoropropenes, tetrafluoropropenes including 1,1,1,2-tetrafluoropropene (HFO-1234yf), 1,1,1,2,3-pentafluoropropene (HFO-1225ye), and 1-chloro-3,3,3-trifluoropropene (HCFC-1233zd). Combinations of any of the aforementioned are useful including blends and azeotropes thereof. The relative amount of any of the above noted additional co-blowing agents, as well as any additional components included in present compositions, can vary widely within the general broad scope of the present invention according to the particular application for the composition, and all such relative amounts are considered to be within the scope hereof.

As used herein, a non-limiting definition for the term “co-blowing agent” which includes mixtures or miscible blends and/or azeotropes of blowing agents, means a one or more co-blowing agents, co-propellants, or co-solvents which are useful and provide efficacy to various applications in the form of performance, pressure performance, or solubility, without deleterious effect due to molar gas volume, flammability mitigation, or GWP reduction. These co-agents include but are not limited to those described previously.

Without being held to any theory or mode of operation, glycerin imparts greater reactivity stability over time. If glycerin is taken out of the reactants, reactivity stability suffers.

In the ensuing tables, a catalytic decay ratio (“CDR”)≤2.5, more preferably≤2 was deemed to pass. For density drift, for a pass, the density should not exceed past +/−25% of the initial value. And for insulation properties, (“R”) values, the R-value must not be below 1.0 of initial value and the closed cell content should be above 80%.

All experiments in this application employed the following recognizing that the exact percentages can vary and still produce acceptable polyurethane foam. Most cans were pressurized to between 130-250 psi (typically using an inert gas, e.g., nitrogen), although several formulations were tested in II-12 cans, which limit pressures from about 70 psig to 130 psig.

| | |
|---|---|
| LBA Expts. | GBA Expts. |

| All Cans* | A-side | B-side | A-side | B-side |
|---|---|---|---|---|
| PMDI | 93% | | 94% | |
| Respective blend | | 86% | | 86-89% |
| 1234ze | 7% | 14% | 6% | 11-14% |
| | 100% | 100% | 100% | 100% |

Optimal A/B Ratio~1:1

TABLE 1

| | #1 | #2 | #3 | #4 | #5 | | | | |
|---|---|---|---|---|---|---|---|---|---|
| | % | % | % | % | % | #6 | #7 | #8 | #9 |
| Polyol(s) | | | | | | | | | |
| Isoexter 3061-US | | | 27.00 | | | | | | |
| PS-1752 | | | | 38.00 | 37.00 | | | | |
| Poly-G 30-168 | 43.00 | 41.00 | | | | | | | |
| Poly-G 37-600 (4.98% | 20.00 | 20.00 | 23.00 | 27.00 | 26.00 | 50.00 | 60.00 | 50.00 | 60.00 |
| N) | | | | | | | | | |
| Poly-G 20-112 | | | | | | | | | |
| Plurocol 2010 | | | 15.00 | | | | | | |
| Poly-G 30-42 | | | | | | | 6.00 | 17.60 | 8.90 |
| Multrinol 8114 | | | | | | | | | |
| (~4.93% N) | | | | | | | | | |
| Poly-Q 40-800 | | | | | | | | | |
| (~10.07% N) | | | | | | | | | |
| Plasticizer | | | | | | | | | |
| TCPP | 27.15 | 27.15 | 27.15 | 27.15 | 27.15 | 27.15 | 27.15 | 27.15 | 27.15 |
| Surfactant(s) | | | | | | | | | |
| Tegostab B-8870 | 4.00 | | 4.00 | 4.00 | | | | | |
| Dabco DC-198 | | | | | | | | 3.00 | 3.00 |
| Surfonic N-95 | | 3.50 | | | 3.50 | 3.50 | 3.50 | | |
| Tegostab B-8465 | | 2.50 | | | 2.50 | 2.50 | 2.50 | | |
| Pluronic L-31 | | | | | | | | | |
| Surfynol 485 | | | | | | | | | |
| Tegostab B-8499 | | | | | | | | | |
| Catalyst(s) | | | | | | | | | |
| Dabco ® T-120/PC3014 | 0.05 | 0.05 | 0.05 | 0.05 | 0.05 | 0.05 | 0.15 | 0.15 | 0.15 |
| Dabco ® TMR-20 | | | | | | | | | |
| Polycat 12 | 0.80 | 0.80 | 0.80 | 0.80 | 0.80 | 0.80 | 0.80 | 0.80 | 0.80 |
| Other Additive(s) | | | | | | | | | |
| Water | 2.00 | 2.00 | 2.00 | 2.00 | 2.00 | 1.30 | | 1.30 | |
| Glycerin | 3.00 | 3.00 | 1.00 | 1.00 | 1.00 | | | | |
| Polyol % by type | | | | | | | | | |
| Polyester Polyol % | 0.00 | 0.00 | 27.00 | 38.00 | 37.00 | 0.00 | 0.00 | 0.00 | 0.00 |
| Polyether Polyol % | 63.00 | 61.00 | 38.00 | 27.00 | 26.00 | 50.00 | 60.00 | 50.00 | 60.00 |
| Theoretical Nitrogen % | 1.054 | 1.054 | 1.203 | 1.403 | 1.350 | 2.549 | 3.047 | 2.549 | 3.047 |
| Expt Nitrogen % | 1.048 | | | | | | | | |
| (ASTM D6979) | | | | | | | | | |
| Physical Properties | | | | | | | | | |
| CDR (6 months) | 1.26 | 1.31 | 1.45 | 1.40 | 1.24 | 1.24 | 1.00 | 1.82 | 1.29 |
| CDR (12 months) | 1.53 | 1.35 | 1.56 | 1.50 | 1.00 | 1.10 | 1.00 | 1.85 | 1.32 |
| | #10 | #11 | #12 | #13 | #14 | #15 | #16 | #17 | #18 |
| Polyol(s) | | | | | | | | | |
| Isoexter 3061-US | | | | | | | | | |
| PS-1752 | | | | | | | | | |
| Poly-G 30-168 | 41.00 | 51.00 | 43.00 | 53.00 | | | | 43.00 | 44.00 |
| Poly-G 37-600 (4.98% N) | | | | | 13.50 | 81.00 | 50.00 | | |
| Poly-G 20-112 | | | | | | | | | |
| Plurocol 2010 | | | | | | | | | |
| Poly-G 30-42 | | | | | | | | | |
| Multrinol 8114 | 20.00 | | 20.00 | | 40.00 | | | 22.00 | 22.00 |
| (~4.93% N) | | | | | | | | | |
| Poly-Q 40-800 | | 10.00 | | 10.00 | | | 25.00 | | |
| (~10.07% N) | | | | | | | | | |
| Plasticizer | | | | | | | | | |
| TCPP | 27.15 | 27.15 | 27.15 | 27.15 | 35.00 | 15.80 | 21.80 | 24.30 | 24.40 |
| Paroil 45/CPAR P-45 | | | | | 5.30 | | | | |
| Surfactant(s) | | | | | | | | | |
| Tegostab B-8870 | | | 4.00 | 4.00 | 2.00 | 3.00 | 3.00 | 4.00 | 4.00 |
| Dabco DC-198 | | | | | | | | | |
| Surfonic N-95 | 3.50 | 3.50 | | | | | | | |
| Tegostab B-8465 | 2.50 | 2.50 | | | 1.00 | | | | |
| Pluronic L-31 | | | | | 1.00 | | | | |
| Surfynol 485 | | | | | | | | | |
| Tegostab B-8499 | | | | | | | | | |
| Catalyst(s) | | | | | | | | | |
| Dabco ® T-120/PC3014 | 0.05 | 0.05 | 0.05 | 0.05 | | 0.20 | 0.20 | | |
| Dabco ® TMR-20 | | | | | 1.00 | | | 1.70 | 1.00 |
| Polycat 12 | 0.80 | 0.80 | 0.80 | 0.80 | 0.80 | | | 0.60 | 0.40 |
| Other Additive(s) | | | | | | | | | |
| Water | 2.00 | 2.00 | 2.00 | 2.00 | 1.40 | | | 1.40 | 1.20 |
| Glycerin | 3.00 | 3.00 | 3.00 | 3.00 | | | | 3.00 | 3.00 |
| Polyol % by type | | | | | | | | | |
| Polyester Polyol % | 0.00 | 0.00 | 0.00 | 0.00 | 0.00 | 0.00 | 0.00 | 0.00 | 0.00 |
| Polyether Polyol % | 61.00 | 61.00 | 63.00 | 63.00 | 53.50 | 81.00 | 75.00 | 65.00 | 66.00 |
| Theoretical Nitrogen % | 1.026 | 1.065 | 1.026 | 1.065 | 2.666 | 4.034 | 5.009 | 1.065 | 1.065 |
| Expt. Nitrogen % | 1.043 | | | 1.074 | 2.700 | | 4.978 | 1.128 | 1.128 |
| (ASTM D6979) | | | | | | | | | |

Physical Properties (measured at 1.048 per ASTM D6979

| | | | | | | | | | |
|---|---|---|---|---|---|---|---|---|---|
| CDR (6 months) | 1.06 | 2.10 | 1.43 | 2.18 | 1.45 | 1.39 | 1.60 | 1.70 | 0.90 |
| CDR (12 months) | 1.00 | 1.80 | 1.50 | 2.51 | 1.73 | 1.39 | 1.90 | 1.86 | 1.10 |

| | #19⁽¹⁾ |
|---|---|
| Polyol(s) | |
| Isoexter 3061-US | |
| PS-1752 | |
| Poly-G 30-168 | |
| Poly-G 37-600 (4.98% N) | 40.00 |
| Poly-G 20-112 | |
| Plurocol 2010 | |
| Poly-G 30-42 | |
| Multrinol 8114 (~4.93% N) | |
| Poly-Q 40-800 (~10.07% N) | |
| Stepanpol 3524 | 27.70 |
| Plasticizer | |
| TCPP | 25.00 |
| Paroil 45/CPAR P-45 | |
| Surfactant(s) | |
| Tegostab B-8870 | 1.50 |
| Dabco DC-198 | |
| Surfonic N-95 | |
| Tegostab B-8465 | |
| Pluronic L-31 | |
| Surfynol 485 | 2.40 |
| Tegostab B-8499 | 1.50 |
| Catalyst(s) | |
| Dabco ® T-120/PC3014 | |
| Dabco ® TMR-20 | |
| Polycat 12 | |
| Dabco K-15 (KC) | 1.30 |
| Dabco TMR-31 | 0.50 |
| DMDEE | 0.10 |
| Other Additive(s) | |
| Water | |
| Glycerin | |
| Polyol % by type | |
| Polyester Polyol % | 27.70 |
| Polyether Polyol % | 40.00 |
| Theoretical Nitrogen % | >1.008 |
| Experimental Nitrogen % | 2.073 |
| (ASTM D6979) | |
| Physical Properties | |
| CDR (6 months) | 1.21 |
| CDR (12 months) | 1.18 |

⁽¹⁾Used liquid blowing agent LBA - HFO-1233zd (1-chloro-3,3,3-trifluoropropene)

As illustrated in the table, minor changes impact properties which is indicative of formulation sensitivity (lack of robustness). Amine-containing polyols, i.e., systems with ether-based polyols and aminopolyols pass shelf life stability.

It is possible to synthesize a polyurethane foam having over a 3% theoretical nitrogen loading by liquid chemical weight analysis and still pass shelf life analysis. Nitrogen steric hindrance appears to be important and reactivity stability is highly dependent on the choice of amino polyol. Without being bound to any one theory or mode of operation, it appears that the nitrogen needs to be shielded from HFO attack. As illustrated by the figure, the type of amine-containing polyol has a strong influence over CDR (catalytic decay ratio), not nitrogen content alone. All blends have theoretical nitrogen content between 1.02 wt. % and 1.07 wt. %. The figure shows that high content amino polyols (e.g., Poly-Q 40-800) with about 10.07 wt. % nitrogen did not synthesize a polyurethane foam with a higher nitrogen content than for example Multrinol 8114 with about 4.84 wt. % nitrogen. However, the less shielded nitrogen in Poly-Q 40-800 clearly produced consistently poorer results as evidenced by the CDR ratios greater than 2.0.

TABLE #2
Physical Properties Characterization

| | Initial | 3 months | 6 months | 9 months | 12 months |
|---|---|---|---|---|---|
| Expt. #1 | | | | | |
| Gel (sec) | 57 | 61 | 72 | 73 | 87 |
| Tack (sec) | 115 | 138 | 155 | 135 | 162 |
| CDR | 1.00 | 1.07 | 1.26 | 1.28 | 1.53 |
| A/B | 1.17 | 1.06 | 1.06 | 1.04 | 1.03 |
| Density pcf | 1.97 | 2.13 | 1.92 | 2.00 | 1.95 |
| R | 5.98 | 6.11 | 5.64 | 5.92 | 5.64 |
| % CCC | 97.27 | 92.53 | 94.12 | 93.63 | 95.08 |
| II comp. (psi) | 18.23 | 12.46 | 13.39 | 12.40 | 11.98 |
| Expt. #2 | | | | | |
| Gel (sec) | 52 | 71 | 68 | 73 | 70 |
| Tack (sec) | 95 | 138 | 145 | 135 | 100 |
| CDR | 1.00 | 1.37 | 1.31 | 1.26 | 1.35 |
| A/B | 1.09 | 1.02 | 1.09 | 1.01 | 1.02 |
| Density pcf | 1.94 | 2.06 | 1.96 | 1.95 | 2.02 |
| R | 6.04 | 5.91 | 5.62 | 3.98 | 3.72 |
| % CCC | 98.03 | 96.21 | 94.13 | 13.53 | 16.28 |
| II comp. (psi) | 16.45 | 13.13 | 16.38 | 19.35 | 19.52 |
| Expt. #3 | | | | | |
| Gel (sec) | 51 | 57 | 74 | 70 | 80 |
| Tack (sec) | 95 | 106 | 166 | 130 | 140 |
| CDR | 1.00 | 1.12 | 1.45 | 1.37 | 1.57 |
| A/B | 1.19 | 1.19 | 1.09 | 1.12 | 1.13 |
| Density pcf | 2.10 | 2.19 | 2.14 | 2.13 | 2.13 |
| R | 5.91 | 4.82 | 4.33 | 4.26 | 4.20 |
| % CCC | 92.72 | 93.79 | 38.96 | 5.40 | 8.36 |
| II comp. (psi) | 16.10 | 17.79 | | 12.76 | 12.36 |
| Expt. #4 | | | | | |
| Gel (sec) | 50 | 69 | 70 | | 75 |
| Tack (sec) | 95 | 106 | 166 | | 140 |
| CDR | 1.00 | 1.38 | 1.40 | | 1.50 |
| A/B | 1.18 | 1.15 | 1.10 | | 0.98 |
| Density pcf | 2.18 | 2.31 | 2.33 | | |
| R | 6.30 | 6.33 | 6.02 | | |
| % CCC | 91.52 | 91.91 | 84.87 | | |
| II comp. (psi) | 18.71 | 15.64 | 17.16 | | |
| Expt. #5 | | | | | |
| Gel (sec) | 55 | 58 | 68 | 65 | |
| Tack (sec) | 80 | 140 | 110 | 130 | |
| CDR | 1.00 | 1.05 | 1.24 | 1.18 | |
| A/B | 1.11 | 0.94 | 0.96 | 0.64 | |
| Density pcf | 2.08 | 1.95 | 1.91 | | |
| R | 5.95 | 6.14 | 3.99 | | |
| % CCC | 91.52 | 91.54 | 46.98 | | |
| II comp. (psi) | 14.03 | 11.05 | 12.80 | | |
| Expt. #6 | | | | | |
| Gel (sec) | 50 | 57 | 62 | | 55 |
| Tack (sec) | 90 | 80 | 100 | | 90 |
| CDR | 1.00 | 1.14 | 1.24 | | 1.10 |
| A/B | 1.05 | 1.06 | 1.04 | | 0.98 |
| Density pcf | 2.09 | 2.01 | 2.21 | | |
| R | 5.41 | 3.94 | 3.46 | | |
| % CCC | 88.73 | 44.40 | 3.45 | | |
| II comp. (psi) | 12.26 | 15.16 | 16.35 | | |
| Expt. #7 | | | | | |
| Gel (sec) | 55 | 45 | 55 | 65 | 55 |
| Tack (sec) | 80 | 70 | 80 | 85 | 90 |
| CDR | 1.00 | 0.82 | 1.00 | 1.18 | 1.00 |
| A/B | 1.11 | 1.15 | 1.09 | 0.80 | 1.07 |
| Density pcf | 3.17 | 2.82 | 3.14 | 3.32 | 2.86 |
| R | 6.03 | 5.33 | 3.71 | 5.16 | 4.56 |
| % CCC | 94.66 | 92.87 | 5.07 | 83.47 | |
| II comp. (psi) | 32.17 | 30.11 | 36.42 | 19.55 | |
| Expt. #8 | | | | | |
| Gel (sec) | 34 | 50 | 62 | 57 | 63 |
| Tack (sec) | 46 | 70 | 90 | 75 | 90 |
| CDR | 1.00 | 1.47 | 1.82 | 1.68 | 1.85 |
| A/B | 1.09 | 0.85 | 0.63 | 1.16 | 1.06 |
| Density pcf | 2.16 | 2.53 | | 2.25 | 2.29 |
| R | 4.58 | 4.22 | | 4.05 | 3.99 |
| % CCC | 94.80 | 2.82 | | 5.78 | 3.46 |
| II comp. (psi) | 12.31 | 12.68 | | 18.13 | 19.28 |
| Expt. #9 | | | | | |
| Gel (sec) | 31 | 33 | 40 | 35 | 41 |
| Tack (sec) | 40 | 50 | 65 | 55 | 65 |
| CDR | 1.00 | 1.06 | 1.29 | 1.13 | 1.32 |
| A/B | 1.21 | 1.09 | 0.83 | 0.89 | 1.04 |
| Density pcf | 3.28 | 3.36 | 3.25 | 3.17 | 3.33 |
| R | 5.67 | 4.81 | 4.16 | 4.18 | 5.51 |
| % CCC | 94.73 | 82.37 | 32.56 | 67.09 | 72.27 |
| II comp. (psi) | 40.68 | 38.69 | 24.24 | 31.20 | 34.00 |
| Expt. #10 | | | | | |
| Gel (sec) | 75 | 78 | 80 | 85 | 75 |
| Tack (sec) | 180 | 165 | 210 | 170 | 150 |
| CDR | 1.00 | 1.04 | 1.07 | 1.13 | 1.00 |
| A/B | 1.07 | 1.11 | 1.12 | 1.07 | 0.93 |
| Density pcf | 2.04 | 1.99 | 2.03 | 2.04 | 1.93 |
| R | 6.01 | 5.70 | 5.68 | 5.47 | 5.56 |
| % CCC | 88.79 | 94.22 | 92.23 | 95.36 | 90.96 |
| II comp. (psi) | 14.66 | 14.14 | 14.18 | 13.27 | 8.12 |
| Expt. #11 | | | | | |
| Gel (sec) | 50 | 90 | 105 | 90 | 90 |
| Tack (sec) | 105 | 255 | 300 | 250 | 285 |
| CDR | 1.00 | 1.80 | 2.10 | 1.80 | 1.80 |
| A/B | 1.06 | 0.99 | 1.04 | 1.02 | 1.05 |
| Density pcf | 2.08 | 2.02 | 2.22 | 2.43 | 2.06 |
| R | 6.15 | 5.19 | 3.86 | 3.69 | 3.40 |
| % CCC | 89.13 | 93.08 | 32.77 | 11.71 | 14.23 |
| II comp. (psi) | 11.89 | 12.32 | 20.95 | 18.08 | 16.93 |
| Expt. #12 | | | | | |
| Gel (sec) | 70 | * | 100 | 90 | 105 |
| Tack (sec) | 200 | * | 225 | 270 | 225 |
| CDR | 1.00 | * | 1.43 | 1.29 | 1.50 |
| A/B | 1.23 | * | 1.36 | 1.33 | 1.14 |
| Density pcf | 2.08 | * | 1.93 | 2.44 | 2.20 |
| R | 5.68 | * | 5.53 | 6.17 | 5.79 |
| % CCC | 91.61 | * | 94.42 | 92.41 | 90.53 |
| II comp. (psi) | 17.17 | * | 15.32 | 16.20 | 15.32 |
| Expt. #13 | | | | | |
| Gel (sec) | 55 | 130 | 120 | 140 | 138 |
| Tack (sec) | 130 | 335 | 360 | 540 | 495 |
| CDR | 1.00 | 2.36 | 2.8 | 2.55 | 2.51 |
| A/B | 1.22 | 1.34 | 1.24 | 1.15 | 1.25 |
| Density pcf | 2.19 | 2.30 | 2.29 | 2.36 | 2.30 |
| R | 5.66 | 5.25 | 5.47 | 5.66 | 5.44 |
| % CCC | 91.10 | 89.36 | 92.16 | 91.02 | 92.04 |
| II comp. (psi) | 14.67 | 22.40 | 18.34 | 15.66 | 18.08 |
| Expt. #14 | | | | | |
| Gel (sec) | 110 | 120 | 160 | | 190 |
| Tack (sec) | 285 | 300 | 540 | | 525 |
| CDR | 1.00 | 1.25 | 1.45 | | 1.73 |
| A/B | 1.25 | 1.18 | 1.18 | | 1.04 |
| Density pcf | 2.06 | 2.07 | 2.42 | | 2.31 |
| R | 5.86 | 5.69 | 5.44 | | 4.69 |
| % CCC | 95.45 | 93.63 | 94.10 | | 86.11 |
| II comp. (psi) | 20.57 | 16.33 | 28.51 | | 26.44 |
| Expt. #15 | | | | | |
| Gel (sec) | 28 | 35 | 39 | 37 | 39 |
| Tack (sec) | 35 | 52 | 53 | 51 | 52 |
| CDR | 1.00 | 1.25 | 1.39 | 1.32 | 1.39 |
| A/B | 1.06 | 1.14 | 0.76 | 1.11 | 0.86 |
| Density pcf | 2.91 | 2.94 | 3.54 | 3.12 | 3.19 |
| R | 6.63 | 6.60 | 5.39 | 6.34 | 5.05 |
| % CCC | 93.41 | 95.66 | 87.86 | 93.54 | 74.40 |
| II comp. (psi) | 34.68 | 33.82 | 22.62 | 36.01 | 29.76 |
| Expt. #16 | | | | | |
| Gel (sec) | 20 | 30 | 32 | 37 | 38 |
| Tack (sec) | 26 | 52 | 52 | 60 | 55 |
| CDR | 1.00 | 1.50 | 1.60 | 1.85 | 1.90 |
| A/B | 1.20 | 1.40 | 1.37 | 1.42 | 1.40 |
| Density pcf | 2.96 | 3.22 | 3.15 | 3.00 | 3.09 |
| R | 6.64 | 3.66 | 3.65 | 5.06 | 6.05 |
| % CCC | 94.57 | | 17.80 | 49.54 | 96.50 |
| II comp. (psi) | 38.96 | 30.22 | 29.13 | 37.45 | 46.12 |
| Expt. #17 | | | | | |
| Gel (sec) | 70 | 93 | 120 | 120 | 130 |
| Tack (sec) | 130 | 160 | 197 | 240 | 240 |
| CDR | 1.00 | 1.33 | 1.71 | 1.71 | 1.86 |
| A/B | 1.24 | 1.10 | 1.10 | 0.98 | 1.00 |
| Density pcf | 1.88 | 1.95 | 1.99 | 2.06 | 2.02 |
| R | 5.54 | 5.87 | 5.68 | 5.56 | 4.02 |
| % CCC | 97.18 | 97.51 | 80.65 | 93.79 | 15.52 |
| II comp. (psi) | 17.25 | 17.77 | 19.70 | 16.40 | 15.66 |
| Expt. #18 | | | | | |
| Gel (sec) | 150 | 153 | 135 | 165 | 165 |
| Tack (sec) | 290 | 285 | 285 | 390 | 320 |
| CDR | 1.00 | 1.02 | 0.90 | 1.10 | 1.10 |
| A/B | 1.19 | 1.12 | 0.92 | 0.99 | 0.97 |
| Density pcf | 2.28 | 2.30 | 2.16 | 2.28 | 2.32 |
| R | 5.67 | 5.88 | 5.14 | 5.31 | 5.44 |
| % CCC | 96.48 | 99.32 | 97.35 | 97.96 | 98.52 |
| II comp. (psi) | 20.47 | 19.14 | 16.87 | 18.17 | 18.05 |
| Expt. #19 | | | | | |
| Gel (sec) | 76 | 82 | 92 | 98 | 90 |
| Tack (sec) | 116 | 107 | 152 | 137 | 158 |
| CDR | 1.00 | 1.08 | 1.21 | 1.29 | 1.18 |
| A/B | 1.15 | 1.20 | 1.27 | 1.22 | 1.17 |
| Density pcf | 3.00 | 3.00 | 3.07 | 3.04 | 2.98 |
| R | 5.82 | 6.74 | 7.40 | 7.25 | 6.15 |
| % CCC | 97.00 | 95.27 | 97.44 | 91.69 | 91.53 |
| II comp. (psi) | 51.19 | 43.14 | 38.70 | 47.50 | 39.38 |

* = data not collected

As illustrated in the data above, Formula #1 exceeds 1% nitrogen by weight of liquid chemical and is a successful formulation pursuant to the identified success criteria. In Formula #2, much like Formula #1 but with a different surfactant package, this formulation appears to have a better CDR, but is not as robust for insulation stability. Formula #3 adds some polyester polyol in order to expand capabilities, and demonstrates that ester polyols are usable in high nitrogen compositions. In Formula #4, despite using a known stable polyester polyol (PS-1752), both formulas inexplicably collapse in aging regardless of two previous surfactant packages and failed.

The theoretical nitrogen content to was increased to ˜3.0% in Formula #7 and the product passes even with no added water as water is known to cause issues with HFO's. Formulas #8 and #9 both pass with the 8870 surfactant package, although CDR is worse in both cases. It is hypothesized that the N95/B8465 surfactant package helps with CDR, while the 8870 helps with insulation stability.

In formulas #10 and #12, Multranol 8114 seems to impart better stability than 37-600 with similar theoretical nitrogen loadings thereby indicating some sort of steric hindrance phenomenon. Similar surfactant trends are noticed here as with previous studies. In formulas #11 and #13, Poly-Q 40-800 has much worse performance than the previous amino polyols despite similar nitrogen loadings in the liquid blends. Similar surfactant trends are noticed here as with previous studies.

For Formula #14, Multranol 8114 and Poly-G 37-600 were used noting that the formulation uses TMR-20, not T-120. Formula #15 increased the theoretical nitrogen threshold to ˜4%. The catalyst PC-12 was removed, the amount of TCPP was reduced while the amount of T-120 was increased to demonstrate faster reactivity. Formula #16 increased theoretical nitrogen threshold to ˜4% and the product passed all metrics. It is noted that this formulation passes insulation at initial, then bottoms out closed cell from 3-6 months, 9 months shows improvement, then 12 months is back to>90% closed cell content.

Formulas #17 and #18 used the catalysts TMR-20+PC-12 in order to change reaction mechanics with Formula #18 being a slower version of Formula #17.

What has been illustrated is that systems with ether-based polyols and/or ester based polyols and “amino polyols” pass shelf life stability. Most formulas presented are at 1-3% theoretical nitrogen loading although it should be noted that it is possible to get a formulation with over 5% theoretical nitrogen by liquid chemical weight to pass shelf life (Formula #16) which has a CDR of 1.60 at 6 months and 1.90 at 12 months.

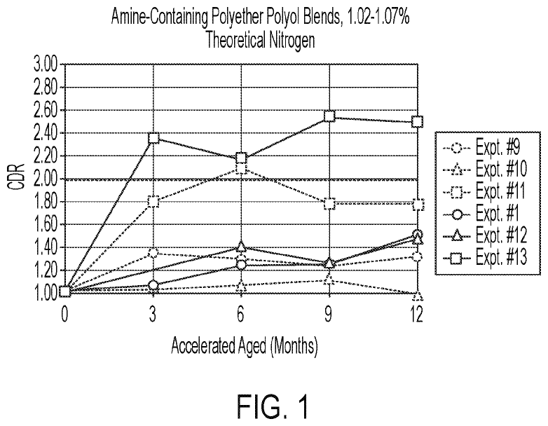

Contrary to the teachings of the Prior Art, which has taught that the more nitrogen in a blend, the worse CDR becomes as seen in FIG. 1, a plot of CDR vs theoretical nitrogen yield a correlation of almost zero.

By removing typical aging culprits (water) and limiting TCPP, it is possible to construct a formula that has 4% and 5% nitrogen loadings (Formula #15 and #16). The issue with these formulations was viscosity concerns. In this application, it is taught that reactivity stability is highly dependent on the choice of amino polyol, but the nitrogen needs to be shielded.

In this application, it is shown that systems with sterically-hindered amines (PC-12) and metal-based catalysts (K and Sn), or simply metal-based catalysts can be employed and that unlike the teachings of the Prior Art, are not limited by the requirement of amine catalysts. It is possible to formulate compositions that react fast (˜0:30 sec to gel) and formulas that react slow (˜2:00 minutes to gel).

To a lesser extent, surfactants play a role in the reactivity shelf life stability of these systems. The tandem of the surfactants N95 and B-8465 are more shelf life stable in reactivity than B8870 (though B8870 seems to have better insulation stability).

Noticeably, Formula #13 has a CDR greater than 2 from 3 months onward yet maintains minimal density drift and does not appear to decrease in insulation and is unique in that it is not stable in reactivity, but is stable for physical properties.

It is noted that when using HFO propellants, not only gaseous HFO propellants are able to be successfully employed in the various compositions but also liquid HFO propellants (as illustrated with Formula #19) which uses HFO 1233zd as the HFO propellant.

In one aspect, the invention provides a polyol premix composition which comprises a combination of a blowing agent, a polyol, a silicone surfactant, and a sterically hindered amine catalyst; wherein the blowing agent comprises a hydrohaloolefin, and optionally a hydrocarbon, fluorocarbon, chlorocarbon, fluorochlorocarbon, halogenated hydrocarbon, CO₂ generating material, or combinations thereof; wherein the sterically hindered amine catalyst has the formula R₁R₂N-[A-NR₃]ₙR₄ wherein each of R₁, R₂, R₃, and R₄ is independently H, a C₁₋₈ alkyl group, a C₁₋₈ alkenyl group, a C₁₋₈ alcohol group, or a C₁₋₈ ether group, or R₁ and R₂ together form a C₅₋₇ cyclic alkyl group, a C₅₋₇ cyclic alkenyl group, a C₅₋₇ heterocyclic alkyl group, or a C₅₋₇ heterocyclic alkenyl group; A is a C₁₋₅ alkyl group, a C₁₋₅ alkenyl group, or an ether; n is 0, 1, 2, or 3; with the proviso that the sterically hindered amine catalyst has a sum of Charton's steric parameters of about 1.65 or greater.

Charton's steric parameters for a group “X” are determined by: comparing the rates of acid catalyzed hydrolysis of substituted esters XCH₂C(O)OR with the rate of the hydrolysis of the corresponding unsubstituted ester. The differences correlate in a linear fashion with the Van der Waals radii of X (see R.W. Taft in “Steric effects in organic chemistry” M.S. Newman, ed., Wiley, New York, NY (1956) p. 556 and M. Charton, J. Am. Chem. Soc., 97 (1975) p. 1552, which are incorporated herein by reference. A list of the values “v” can be found in M. Charton, J. Organic Chemistry, 41(12) (1976) p. 2217-2220, which is incorporated herein by reference.

In another aspect of the invention, the sterically hindered amine component contains at least one sterically hindered tertiary amine catalysts and at least one sterically hindered secondary amine catalyst. The polyol premix composition may optionally further comprise a non-amine catalyst. Suitable non-amine catalysts may comprise an organometallic compound containing bismuth, lead, tin, titanium, antimony, uranium, cadmium, cobalt, thorium, aluminum, mercury, zinc, nickel, cerium, molybdenum, vanadium, copper, manganese, zirconium, sodium, potassium, or combinations thereof. These non-exclusively include bismuth nitrate, lead 2-ethylhexoate, lead benzoate, ferric chloride, antimony trichloride, antimony glycolate, stannous salts of carboxylic acids, zinc salts of carboxylic acids, dialkyl tin salts of carboxylic acids, potassium acetate, potassium octoate, potassium 2-ethylhexoate, glycine salts, quaternary ammonium carboxylates, alkali metal carboxylic acid salts, and N-(2-hydroxy-5-nonylphenol) methyl-N-methylglycinate, tin (II) 2-ethyl hexanoate, dibutyltin dilaurate, or combinations thereof. When the optional non-amine catalyst is used, it is usually present in the polyol premix composition in an amount of from about 0.01 wt. % to about 2.5 wt. %, preferably from about 0.05 wt. % to about 2.25 wt. %, and more preferably from about 0.10 wt. % to about 2.00 wt. %. by weight of the polyol premix composition. While these are usual amounts, the quantity amount of metallic catalyst can vary widely, and the appropriate amount can be easily determined by those skilled in the art.

The quantification of steric effects has been a source of some controversy and several parameters have been developed, both experimentally and computationally, and applied with varying degrees of success in biological and chemical settings. Assessing the origin and derivation of some of the most widely known parameters yields insight into how and when they may be appropriately used. Winstein-Holness values (A-values) arise from the conformational study of mono-substituted cyclohexane rings. A-values are based on the observed equilibrium of conformers in mono-substituted cyclohexane rings, where perturbation of this equilibrium is presumably due to 1,3-diaxial steric repulsion. Interference values are another example of an experimentally determined steric parameter and are based on the heat-induced half-life of racemization in 2,2′-substituted biphenyl systems. The steric interaction between the substituent R and the opposing aryl ring is presumed to be the key factor responsible for the different energies required for racemization of the atrop-isomers. Molar refractivity, a steric parameter found in many early QSAR studies is defined by the Lorentz-Lorenz equation and has proven to be an adequate descriptor of total steric volume but disregards molecular shape. Another steric parameter that has had a wide impact on the organometallic community is the Tolman cone angle. Tolman and others have measured projected cone angle of phosphine substituents from a hypothetical metal center. However, the scope of this parameterization may be limited to phosphite ligands. A widely used steric parameter in QSAR studies and other branches of chemistry is the Taft parameter. Taft developed these parameters in his efforts to delineate steric effects from electronic effects in aliphatic ester hydrolysis, by means analogous to those used to derive Hammett's electronic parameters. Taft hypothesized that, under acid-catalyzed conditions, the preservation of charge through the rate-determining step would diminish any inductive or resonance electronic contributions from the R substituents. More recently, Charton found a correlation between Taft's experimentally measured rates and the calculated minimum van der Waals radii of each symmetrical substituent.

A slightly different approach, but building on the Charton work, is that of Kaid Harper, Elizabeth Bess and Metthew Sigman in their paper published in Nature Chemistry Published online 18 Mar. 2012 and titled “Multidimensional steric parameters in the analysis of asymmetric catalytic reactions” pages 366-374. Yet another variant employs Winstein-Holness parameters (A-value) as a metric for steric hindrance. The Tolman cone angles are yet another approach as well as the Taft steric effects.

In the following further embodiments are disclosed:

In a first embodiment, a low-pressure two-component polyurethane foam composition is described in which “A-side” and “B-side” reactants comprise:
at least one A-side diisocyanate and at least one HFO propellant;
at least one B-side polyol, wherein the at least one B-side polyol comprises
   at least one aminopolyol,
   at least one B-side plasticizer,
   at least one surfactant,
   at least one catalyst,
      wherein the at least catalyst is a metal-based catalyst; and
   at least one HFO propellant;
wherein a theoretical nitrogen content of the polyurethane foam composition is greater than 1.0 wt. %; and
a catalytic decay ratio of the polyurethane foam being approximately equal to or less than 2.5.

In a second embodiment of the first embodiment, the at least one catalyst is at least two catalysts, and further wherein at least one of the at least two catalysts is a nitrogen-containing catalytic compound has at least one 6-membered ring groups attached to the nitrogen.

In a third embodiment of the first embodiment, the at least one nitrogen-containing catalytic compound has at least two 6-membered ring groups attached to the nitrogen.

In a fourth embodiment of the third embodiment, the at least one nitrogen-containing catalytic compound is n-methyldicyclohexylamine; and the at least one metal-containing catalytic compound is di-N-butylbis(dodecylthio)tin.

In a fifth embodiment of the first embodiment, the at least one amino polyol contains less than or equal to approximately 8 wt. % nitrogen.

In a sixth embodiment of the fifth embodiment, the at least one amino polyol contains less than or equal to approximately 7 wt. % nitrogen.

In a seventh embodiment of the sixth embodiment, the at least one amino polyol contains less than or equal to approximately 6 wt. % nitrogen.

In an eighth embodiment of seventh embodiment, the at least one amino polyol contains less than or equal to approximately 5 wt. % nitrogen.

In a ninth embodiment of the eighth embodiment, the at least one amino polyol contains less than or equal to approximately 4 wt. % nitrogen.

In a tenth embodiment of the first embodiment, the B-side further comprises: less than approximately 2.5 wt. % of added water; and less than approximately 5 wt. % of added glycerin.

In an eleventh embodiment of the first embodiment, the at least one amino polyol is selected from the group consisting of

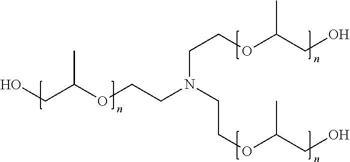

wherein n ranges from 1 to 50

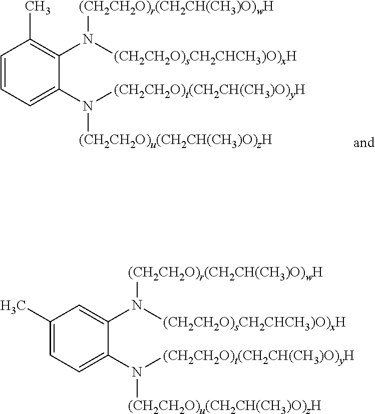

wherein 1<r+s+t+u+v+w+x+y+z<8.5; and further wherein
r, s, t, u, v, w, x, y and z independently range from 0 to 10 inclusive; and

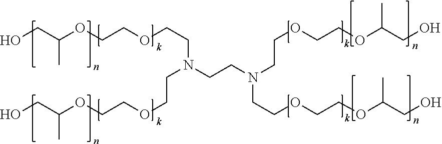

wherein n and k independently range from 1 to 25 inclusive.

In a twelfth embodiment of the eleventh embodiment, the at least one amino polyol is selected from the group consisting of

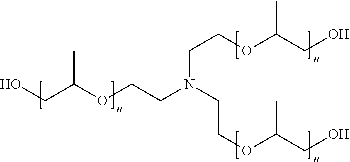

wherein n ranges from 1 to 50; and

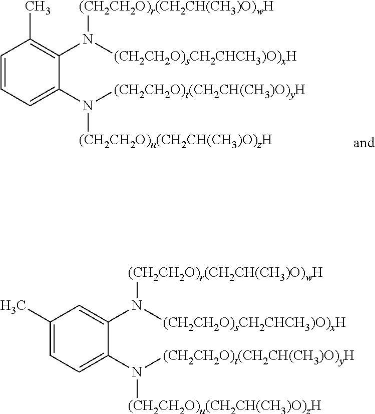

wherein 1<r+s+t+u+v+w+x+y+z<8.5; and further wherein
r, s, t, u, v, w, x, y and z independently range from 0 to 10 inclusive.

In a thirteenth embodiment of the eleventh embodiment, the at least one HFO propellant is a liquid HFO propellant at room temperature and pressure.

In a fourteenth embodiment of the eleventh embodiment, the at least one HFO propellant is a gaseous HFO propellant at room temperature and pressure.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A low-pressure two-component polyurethane foam composition in which “A-side” and “B-side” reactants comprise:
at least one A-side diisocyanate and at least one HFO propellant;
at least one B-side polyol, wherein the at least one B-side polyol comprises
at least one aminopolyol,
at least one B-side plasticizer,
at least one surfactant,
at least one catalyst,
wherein the at least catalyst is a metal-based catalyst; and
at least one HFO propellant;
wherein a theoretical nitrogen content of the polyurethane foam composition is greater than 1.0 wt. %; and
a catalytic decay ratio of the polyurethane foam being approximately equal to or less than 2.5.

2. The low-pressure two-component polyurethane foam composition of claim 1 wherein the at least one catalyst is at least two catalysts, and further wherein at least one of the at least two catalysts is
a nitrogen-containing catalytic compound has at least one 6-membered ring groups attached to the nitrogen.

3. The low-pressure two-component polyurethane foam composition of claim 1 wherein
the at least one nitrogen-containing catalytic compound has at least two 6-membered ring groups attached to the nitrogen.

4. The low-pressure two-component polyurethane foam composition of claim 3 wherein
the at least one nitrogen-containing catalytic compound is n-methyldicyclohexylamine; and
the at least one metal-containing catalytic compound is di-N-butylbis(dodecylthio)tin.

5. The low-pressure two-component polyurethane foam composition of claim 1 wherein
the at least one amino polyol contains less than or equal to approximately 8 wt. % nitrogen.

6. The low-pressure two-component polyurethane foam composition of claim 5 wherein
the at least one amino polyol contains less than or equal to approximately 7 wt. % nitrogen.

7. The low-pressure two-component polyurethane foam composition of claim 6 wherein
the at least one amino polyol contains less than or equal to approximately 6 wt. % nitrogen.

8. The low-pressure two-component polyurethane foam composition of claim 7 wherein
the at least one amino polyol contains less than or equal to approximately 5 wt. % nitrogen.

9. The low-pressure two-component polyurethane foam composition of claim 8 wherein
the at least one amino polyol contains less than or equal to approximately 4 wt. % nitrogen.

10. The low-pressure two-component polyurethane foam composition of claim 1 wherein the B-side further comprises:
less than approximately 2.5 wt. % of added water; and
less than approximately 5 wt. % of added glycerin.

11. The two-component polyurethane foam composition of claim 1 wherein
the at least one amino polyol is selected from the group consisting of 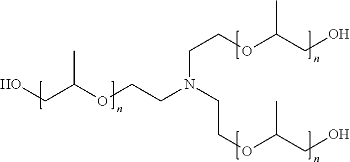
wherein n ranges from 1 to 50 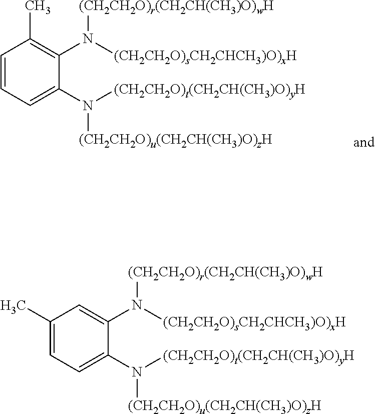
wherein 1<r+s+t+u+v+w+x+y+z<8.5; and further wherein
r, s, t, u, v, w, x, y and z independently range from 0 to 10 inclusive; and 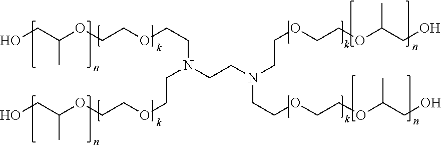
wherein n and k independently range from 1 to 25 inclusive.

12. The two-component polyurethane foam composition of claim 11 wherein
the at least one amino polyol is selected from the group consisting of 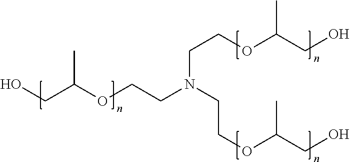
wherein n ranges from 1 to 50; and 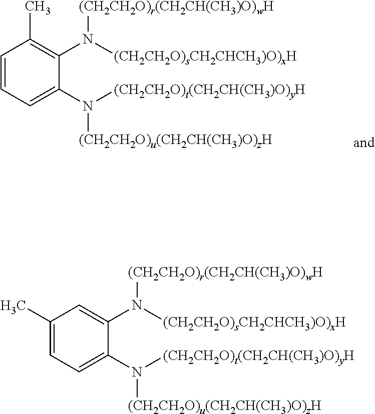
wherein 1<r+s+t+u+v+w+x+y+z<8.5; and further wherein
r, s, t, u, v, w, x, y and z independently range from 0 to 10 inclusive.

13. The two-component polyurethane foam composition of claim 11 wherein
the at least one HFO propellant is a liquid HFO propellant at room temperature and pressure.

14. The two-component polyurethane foam composition of claim 11 wherein
the at least one HFO propellant is a gaseous HFO propellant at room temperature and pressure.
